(19) United States
(12) Patent Application Publication
(10) Pub. No.: US 2003/0175066 A1
(43) Pub. Date: Sep. 18, 2003

(54) Retractable pencil apparatus

(76) Inventor: Lawrence Steckler, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/382,805

(22) Filed: Mar. 5, 2003

Related U.S. Application Data
(60) Provisional application No. 60/361,444, filed on Mar. 5, 2002.

(51) Int. Cl. B43K 25/00

(52) U.S. Cl. 401/131; 401/52

(57) ABSTRACT

A retractable pencil apparatus that threadably receives a lead pencil and preferably attaches to a compact spring actuated automatic rewinding reel known in the art. Such retractable pencil apparatus comprising an elongated body having a first end portion, a recessed end portion, and a tapered portion disposed between the first end portion and the recessed end portion. Said first end portion having a horizontally positioned interior threaded bore disposed therein, said interior bore sized to threadably receive the lead pencil. Said recessed end portion having an aperture therethrough, said aperture sized to receive a standard key ring that is attached to the compact spring actuated automatic rewinding reel.

### CROSS REFERENCES TO RELATED APPLICATIONS

U.S. Provisional Application for Patent 60/361,444, filed Mar. 5, 2002, with title, “Retractable Pencil Apparatus” which is hereby incorporated by reference. Applicant claims priority pursuant to 35 U.S.C. par. 119(e)(i).

Statement as to rights to inventions made under Federally sponsored research and development: Not Applicable

### BACKGROUND OF THE INVENTION

1. Field of the Invention

This invention relates to a retractable pencil apparatus that threadably receives a lead pencil and preferably attaches to a compact spring actuated automatic rewinding reel known in the art.

2. Background of the Invention

A variety of tradesmen typically use lead pencils in performing their jobs. Tradesmen such as construction workers may use a lead pencil for example, to make various notes, and for marking measurements on the job site. Such tradesmen typically carry their pencil throughout the day either in their front shirt pocket, or place the pencil behind their ear between the ear and the side of the tradesman's head. Throughout a day, it is typical for the tradesman to either misplace or permanently lose their pencil, causing delays and often frustration. Replacement of lost pencils is not only inconvenient, but costly.

As will be seen from the subsequent description, the preferred embodiment of the present invention overcome these and other shortcomings of prior art. The present invention relates to a retractable pencil apparatus that threadably receives a lead pencil. Said apparatus is preferably attached to a line on a standard compact spring actuated automatic rewinding reel known in the art, which rewinding reel is carried by the tradesman. When the draftsman desires to utilize the lead pencil, the lead pencil with the retractable pencil apparatus attached thereto is available by simply pulling the lead pencil and the retractable pencil apparatus from the reel carried by the tradesman. The retractable pencil apparatus remains attached to the line of the reel. As such, the apparatus having the lead pencil attached thereto remains attached to the reel and the tradesman. When the tradesman no longer desires use of the lead pencil, the tradesman simply directs the lead pencil and the retractable pencil apparatus to the reel attached to the tradesman. The reel having spring actuated means that automatically rewinds the line back to the reel.

### SUMMARY OF THE INVENTION

The present invention is a retractable pencil apparatus that threadably receives a lead pencil and preferably attaches to a compact spring actuated automatic rewinding reel known in the art, which rewinding reel is carried by a tradesman. The apparatus of the present invention in particular, is designed to prevent the tradesman from either misplacing or permanently losing their pencil on the job site. The retractable pencil apparatus generally including an elongated body having a first end portion, a recessed end portion, and a tapered portion disposed between the first end portion and recessed end portion. Said first end portion having a horizontally positioned interior bore that extends substantially the length of the first end portion of the elongated body. The retractable pencil apparatus further includes a pencil engaging end which said pencil engaging end is in communication with the first end portion. The pencil engaging end having an opening to the interior bore of the first end portion. Said interior bore is internally threaded and sized to threadably receive a lead pencil. An end of the lead pencil is threadingly engaged with the threaded interior bore of the first end portion. The outer peripheral surface of the pencil is tightly received within the interior bore and tightly seated against the threaded interior bore of the first end portion. In use, the retractable pencil apparatus is attached to a standard key ring by attaching a key ring through an aperture of the pencil apparatus. The said key ring attached to a line on the compact spring actuated automatic rewinding reel known in the art, said reel is generally carried by the tradesman. When the tradesman desires to utilize the lead pencil, the lead pencil with retractable pencil apparatus is attached thereto is available by simply pulling the lead pencil and the retractable pencil apparatus from the reel carried by the tradesman. The retractable pencil apparatus remains attached to the line of the reel. As such, the apparatus having the lead pencil attached thereto remains attached to the reel and the tradesman. When the tradesman no longer desires use of the lead pencil, the tradesman simply directs the lead pencil and the retractable pencil apparatus back to the reel attached to the tradesman. The reel having spring actuated means that automatically rewinds the line back to the reel.

### BRIEF DESCRIPTION OF THE DRAWINGS

FIG. 1 is a side view of a preferred embodiment of the present invention, namely a retractable pencil apparatus.

FIG. 2 is a sectional side view of the apparatus of FIG. 1, illustrating the interior bore of the apparatus.

FIG. 3 illustrates a top view of the apparatus of FIG. 1.

FIG. 4 illustrates a front view of the apparatus of FIG. 1.

FIG. 5 shows a lead pencil.

### DESCRIPTION OF THE PREFERRED EMBODIMENTS

In accordance with the present invention, a retractable pencil apparatus is disclosed. The retractable pencil apparatus relates to an apparatus that threadably receives a lead pencil, and is attached to a line on a standard compact spring actuated automatic rewinding reel known in the art, which rewinding reel is carried by the tradesman. Specifically, it will be noted in the drawing that the retractable pencil apparatus relates to a device designed to prevent the tradesman from either misplacing or permanently losing their lead pencil on the job site. In the broadest context, the retractable pencil apparatus consists of components configured and collated with respect to each other so as to attain the desired objective.

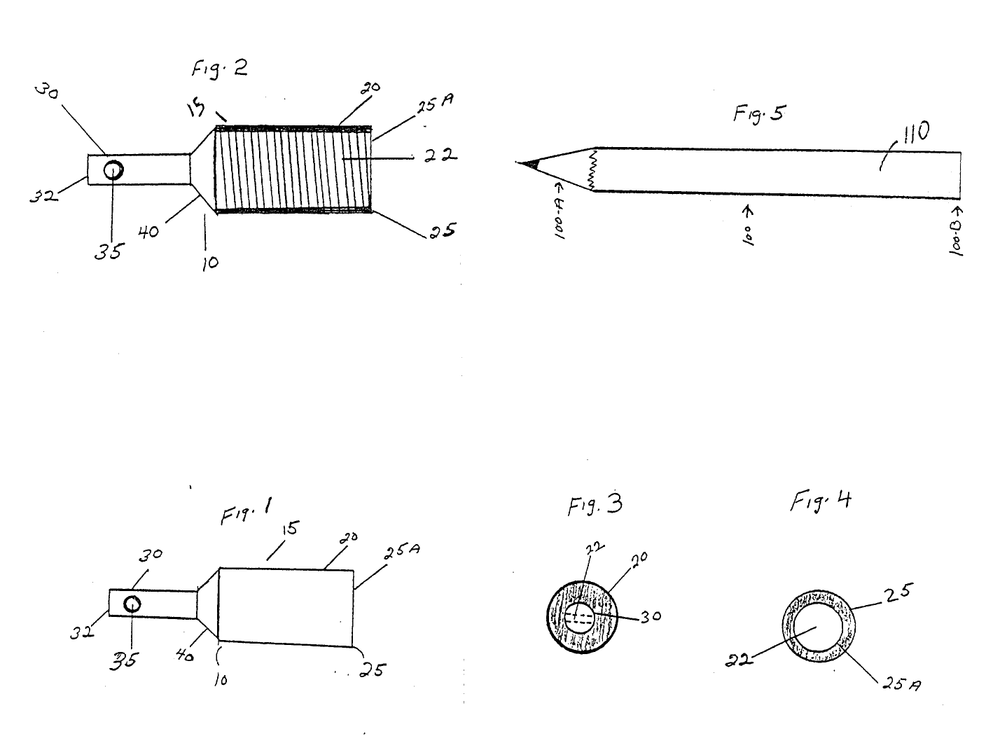

FIGS. 1-2 illustrate a preferred embodiment of a retractable pencil apparatus 10 made in accordance with the present invention. The retractable pencil apparatus 10 of the present invention receives a lead pencil 100 (shown in FIG. 5), and is preferably attached to a standard spring actuated automatic rewinding reel (not shown) known in the art.

The preferred embodiment includes an elongated body 15 having a first end portion 20, a recessed end portion 30, and a tapered portion 40 disposed between the first end portion 20 and the recessed end portion 30, said tapered portion 40 located approximately midway the length of the elongated body 15.

Said first end portion 20 having a horizontally positioned interior bore 22 that extends substantially the length of the first end portion 20 of the elongated body 15. The retractable pencil apparatus 10 further includes a pencil engaging end 25. In particular, the pencil engaging end 25 is disposed at an end of the first end portion 20 opposite the tapered portion 40, and in communication with the first end portion 20.

As shown in FIGS. 1-4, the pencil engaging end 25 having an opening 25A to access the interior bore 22 of the first end portion 20. The retractable pencil apparatus 10 further includes a closed end 32 disposed at an end of the recessed end portion 30 opposite the tapered portion 40, and in communication with the recessed end portion 30. As such, the pencil engaging end 25 is disposed on one end of the apparatus 10 opposite the closed end 32.

The interior bore 22 is internally threaded and sized to threadably receive the lead pencil 100. As shown in FIG. 5, said lead pencil 100 having a writing end 100A and a flat end 100B. In application, said flat end 100B of said lead pencil 100 being threadably received within the interior bore 22 of the first end portion 20.

Said recessed end portion 30 having an aperture 35 therethrough, said aperture 35 disposed near the closed end 32 of the retractable pencil apparatus 10. In the preferred embodiment, said aperture 35 sized to receive a standard key ring (not shown).

As further shown in FIGS. 1-2, the circumference of the recessed end portion 30 is less than the circumference of the first end portion 20. As a result, the recessed end portion 30 extends from the closed end 32 of the retractable pencil apparatus 10 and terminates at the tapered portion 40. The first end portion 20 extends from the tapered portion 40 at the approximate midway of the length of the elongated body 15, and terminates at the pencil engaging end 25. Said first end portion 20, and said recessed end portion 30, and said tapered portion 40 having a generally cylindrical configuration.

As shown in FIG. 5, prior to application, an outer peripheral surface 110 of the flat end 100B of the lead pencil 100 is substantially smooth. In operation, the flat end 100B of the lead pencil 100 is threadingly engaged with the threaded interior bore 22 of the first end portion 20. Since at first, the outer peripheral surface 110 of the flat end 100B is substantially smooth, the flat end 100B of the lead pencil 100 is tightly received in the interior bore 22. As a result, the outer peripheral surface 110 of the flat end 100B frictionally resists the threading rotation between the flat end 100B of the pencil 100 and the interior bore 22 of the first end portion 20.

The outer peripheral surface 110 of the flat end 100B is tightly received within the interior bore 22. The flat end 100B of the pencil 100 being tightly seated against the threaded interior bore 22 of the first end portion 20, resists relative unthreading of the flat end 100B of the pencil 100 and the interior bore 22. In addition, as a result of the said threading rotation between the flat end 100B and the interior bore 22, such frictional resistance forming external threading on the outer peripheral surface of the flat end 100B in threadingly contact with the interior bore 22.

If it is desired to remove the lead pencil 100 from the pencil apparatus 10, the lead pencil 100 is unthreaded from engagement with the apparatus 10. Thereafter, the lead pencil 100 now having said threaded outer peripheral surface 110, may be re-threadingly engaged with the interior bore 22 of the first end portion 20 by threading the threaded outer peripheral surface of the flat end 100B with the internal threads of the interior bore 22.

In use, the retractable pencil apparatus 10 is attached to the standard key ring by attaching the key ring through the aperture 35 of the pencil apparatus 10. The said key ring attached to a line on the compact spring actuated automatic rewinding reel known in the art, said reel is generally carried by the tradesman. When the tradesman desires to utilize the lead pencil 100, the lead pencil 100 with the retractable pencil apparatus 10 threadingly attached thereto is available by simply pulling the lead pencil 100 and the retractable pencil apparatus 10 from the reel carried by the tradesman. The retractable pencil apparatus 10 remains attached to the line of the reel. As such, the apparatus 10 having the lead pencil 100 attached thereto remains attached to the reel and the tradesman. When the tradesman no longer desires use of the lead pencil 100, the tradesman simply directs the lead pencil 100 and the retractable pencil apparatus 10 back to the reel attached to the tradesman. The reel having spring actuated means that automatically rewinds the line back to the reel.

Although the description above contains many specificities, these should not be construed as limiting the scope of the invention but as merely providing illustrations of a preferred embodiment of this invention.

Thus the scope of the invention should be determined by the appended claims in the formal application and their legal equivalents, rather than by the examples given.

I claim:

1. A retractable pencil apparatus that threadably receives a lead pencil and is attached to a standard spring actuated automatic rewinding reel, said retractable pencil apparatus comprising:
an elongated body having a first end portion, a recessed end portion, and a tapered portion disposed between the first end portion and the recessed end portion, said first end portion having an interior threaded bore that extends the length of the first end portion of the elongated body,
a pencil engaging end disposed at one end of the first end portion opposite the tapered portion and in communication with the first end portion, said pencil engaging end having an opening to access the interior threaded bore of the first end portion, said interior bore sized to threadably receive the lead pencil,
wherein the lead pencil comprising a writing end and a flat end,
wherein the flat end of the lead pencil is threadingly engaged with the threaded interior bore of the first end portion,
wherein said recessed end portion having an aperture therethrough, said aperture sized to receive a standard key ring.

2. A retractable pencil apparatus that receives a lead pencil, said retractable pencil apparatus comprising:
an elongated body having a first end portion, a recessed end portion, and a tapered portion disposed between the first end portion and the recessed end portion, said first end portion having an interior threaded bore and a pencil engaging end disposed at one end of the first end portion opposite the tapered portion, said pencil engaging end having an opening to access the interior threaded bore of the first end portion, said interior bore sized to receive the lead pencil,
wherein the lead pencil comprising a writing end and a flat end,
wherein the flat end of the lead pencil is engaged with the threaded interior bore of the first end portion.

3. A retractable pencil apparatus that receives a lead pencil, said retractable pencil apparatus comprising:
an elongated body having a first end portion, a recessed end portion, and a tapered portion disposed between the first end portion and the recessed end portion, said first end portion having an interior bore sized to receive the lead pencil,
wherein the lead pencil comprising a writing end and a flat end,
wherein the flat end of the lead pencil is engaged with the interior bore of the first end portion.
